(19) United States
(12) Patent Application Publication
(10) Pub. No.: US 2026/0186136 A1
(43) Pub. Date: Jul. 2, 2026

(54) BUS ADAPTER DEVICE FOR ULTRASONIC SENSORS, DRIVING ASSISTANCE SYSTEM, AND VEHICLE

(71) Applicant: Robert Bosch GmbH, Stuttgart (DE)

(72) Inventors: Micha Kalbhenn, Ludwigsburg (DE); Albrecht Klotz, Leonberg (DE); Bayar Bayarsaikhan, Leonberg (DE); Michael Gerlach, Weil Der Stadt (DE)

(21) Appl. No.: 18/840,620

(22) PCT Filed: Apr. 5, 2023
(86) PCT No.: PCT/EP2023/059013

§ 371 Date: Aug. 22, 2024

(30) Foreign Application Priority Data
Apr. 13, 2022 (DE) 10 2022 203 762.6

(51) Int. Cl. G01S 15/931; G01S 7/52; G01S 7/521

(52) U.S. Cl. CPC G01S 15/931; G01S 7/52004; G01S 7/521; G01S 2015/932; G01S 2015/938

(57) ABSTRACT

An adapter device for arrangement within an electrical communication connection between an ultrasonic sensor and a control unit or a central processing unit of a vehicle. The adapter device includes: an adapter signal input configured to be electrically connected to a sensor signal output of the ultrasonic sensor and to provide a sensor signal of the ultrasonic sensor; and an adapter signal output configured to generate an output signal of the adapter device for a vehicle bus. The adapter device further includes an adapter device housing and a control ASIC). The control ASIC is arranged in the adapter device housing and is configured to capture the provided sensor signal and to generate an ASIC output signal depending on the captured sensor signal. The control ASIC is also configured to control the ultrasonic sensors based on a specified transmission pattern.

### FIELD

The present invention relates to an adapter device for arrangement within an electrical communication connection between an ultrasonic sensor and a central or zonal processing unit of a vehicle. The present invention also relates to a driving assistance system comprising the adapter device, for example a parking pilot system. Furthermore, the present invention relates to a vehicle comprising the driving assistance system according to the present invention.

### BACKGROUND INFORMATION

A parking pilot system as a driving assistance system for a vehicle typically includes a plurality of ultrasonic sensors and a control device. The control device captures the sensor signals or sensor data from the ultrasonic sensors, which represent distance data. The control device subsequently ascertains object positions on the basis of the distance data and outputs warnings about possible obstacles in the environment of the vehicle to the user of the vehicle. For this purpose, a plurality of ultrasonic sensors is arranged, for example, on the front and rear shock absorbers of the vehicle across the entire width of the vehicle. The number and the arrangement positions of the sensors depend on the range of functions of the system. The ultrasonic sensors transmit an ultrasonic signal. The transmitted ultrasonic signal is reflected on obstacles and received again as an echo signal or reflection signal by the ultrasonic sensors. The distance is generally ascertained depending on the transit time of a direct and/or indirect echo signal of a transmitted ultrasonic signal by means of a sensor ASIC of the corresponding ultrasonic sensor, which is arranged in the sensor housing. The ascertained distance information is generally sent or transmitted together with some other properties or additional information via the received echo signal to the control device of the vehicle. According to the related art, no further processing or preparation of the sensor data takes place between the ultrasonic sensor and the control device. The control device typically ascertains an object position according to the trilateration principle depending on the transmitted distance information and the transmitted additional information. When applying the trilateration principle, the ultrasonic sensor adjacent to a transmitting ultrasonic sensor on the right and/or left is configured to receive a cross echo (indirect reflection signal) of the transmitted ultrasonic signal which was transmitted by the adjacent ultrasonic sensor. For this purpose, the ultrasonic sensors must be synchronized with respect to the transmission of the ultrasonic signal and the reception of the echo signal, which takes place according to the related art by means of the control device. In the case of autonomous driving functions, braking or steering interventions can subsequently be triggered depending on the ascertained object position.

An object of the present invention is to improve control of ultrasonic sensors and communication with ultrasonic sensors.

### SUMMARY

The object may be achieved according to features of the present invention.

The present invention relates to an adapter device for arrangement within an electrical communication connection between an ultrasonic sensor and a central or zonal processing unit of a vehicle. According to an example embodiment of the present invention, the adapter device includes at least an adapter signal input, an adapter signal output, an adapter device housing and a control ASIC, wherein the control ASIC is arranged in the adapter device housing. The adapter signal input is configured to be connected to one or more sensor signal outputs of the at least one ultrasonic sensor and to provide a sensor signal of the ultrasonic sensor or the sensor signals of the ultrasonic sensors. The provided sensor signal represents sensor data from at least one ultrasonic sensor. Preferably, the provided sensor signal represents sensor data from three ultrasonic sensors connected to one another by means of an ultrasonic bus. These sensor data advantageously comprise at least distance data, wherein the distance data have been ascertained depending on an echo signal, received by the corresponding ultrasonic sensor, of a transmitted ultrasonic signal by means of a corresponding sensor ASIC of the corresponding ultrasonic sensor. Advantageously, the sensor data may comprise additional information; for example, the sensor data comprise, as additional information, additional properties of the underlying received echo signal that are associated with the distance data, for example an ascertained correlation coefficient between the received echo signal and the transmitted ultrasonic signal and/or an ascertained number of reflections in the echo signal of the transmitted ultrasonic signal. The adapter signal output of the adapter device is configured to provide or generate an output signal of the adapter device for a vehicle bus. In other words, the adapter signal output of the adapter device is configured to generate an output signal of the adapter device for a vehicle bus connection to the central or zonal processing unit. The vehicle bus or the vehicle bus connection is, for example, a CAN bus, in particular a private CAN bus. Advantageously, the output signal of the adapter device that is provided at the adapter signal output represents at least the sensor data provided at the adapter signal input and/or optionally preprocessed sensor data, wherein the output signal provided at the adapter signal output is preferably prepared or adapted for a standardized communication interface of the vehicle bus; for example, the output signal, provided at the adapter signal output, for a vehicle bus is a CAN bus signal or an Ethernet bus signal. In other words, the sensor signal of the ultrasonic bus that is provided or captured at the adapter signal input differs from the output signal, provided or generated at the adapter signal output, for a vehicle bus, in particular by the type of data formatting or the communication protocol. This data formatting takes place in particular by means of the control ASIC or an optional downstream processing unit. According to the present invention, the control ASIC is electrically connected to the adapter signal input and is configured to capture the provided sensor signal and to generate an ASIC output signal of the control ASIC depending on the captured sensor signal at an ASIC signal output. The generated ASIC output signal of the control ASIC is in particular provided, as an output signal of the adapter device, at the adapter signal output. In other words, the ASIC signal output and the adapter signal output are advantageously electrically connected. The ASIC output signal generated on the basis of the captured sensor signal and the output signal of the adapter device are advantageously, but not necessarily, identical. The output signal of the adapter device is advantageously suitable for transmission at the standardized communication interface for the vehicle bus. Furthermore, the control ASIC is configured to control the at least one ultrasonic sensor or a plurality of ultrasonic sensors on the basis of a specified transmission pattern, in particular for synchronizing a plurality of ultrasonic sensors. By controlling the ultrasonic sensor(s) electrically connected to the adapter signal input, a clocked activation of the ultrasonic sensors for transmitting the ultrasonic signal and in particular a synchronization between the respectively transmitted ultrasonic signal and the reception of the echo signal by means of at least one of the ultrasonic sensors advantageously take place on the basis of the specified transmission pattern. The control of the ultrasonic sensors for transmitting the ultrasonic signal or for receiving the echo signal preferably takes place by switching a corresponding current or voltage supply in the corresponding ultrasonic sensor by means of a switching signal of the control ASIC, wherein the switching signal is in particular transmitted by the ultrasonic bus between the adapter device and the interconnected ultrasonic sensors. The present invention results in the advantage that a flexible and cost-effective adaptation of the ultrasound system to the different system architectures, in particular the different vehicle buses of different manufacturers, is facilitated. The present invention makes standardized communication interfaces of the vehicle bus on the adapter device and on the central or zonal processing unit possible, for example for a CAN bus. This advantageously achieves standardization of the communication protocols on the central or zonal processing unit. The present invention also has the advantage that the connection between the adapter device and the ultrasonic sensor is not subject to standardization. Furthermore, the integration of a control ASIC into the central or zonal processing unit of the vehicle is avoided, whereby higher standardization of the corresponding processing unit is achieved. In addition, the present invention avoids unnecessary cable costs and/or makes transmission of larger data volumes from the adapter device to the central or zonal processing unit possible (e.g., via CAN bus or Ethernet bus). By increasing the data volume that can be transmitted, newer types of ultrasonic sensors and/or a larger number of ultrasonic sensors connected to one another by means of the ultrasonic bus can be used and/or the frequency of the transmitted ultrasonic signals and the frequency of the captured echo signals can be increased and/or more precise data can be provided to the central processing unit.

In an optional embodiment of the present invention, the adapter device comprises a downstream processing unit in the adapter device housing, which downstream processing unit is electrically connected to an ASIC signal output of the control ASIC and to the adapter signal output and is configured such that the downstream processing unit preprocesses the sensor data. This preprocessing carried out by the downstream processing unit comprises at least one capture of the ASIC output signal generated by the control ASIC. Subsequently, object positions between the vehicle and an object in the environment of the vehicle are ascertained on the basis of the distance data of the sensor data, in particular by means of a trilateration method. Optionally, it may be provided that the preprocessing carried out by the downstream processing unit comprises a plausibility check and/or filtering of distance data and/or object positions assessed as irrelevant, on the basis of additional information in the sensor data. Furthermore, creation of a map of the environment of the vehicle depending on the ascertained plausibilized or filtered object positions and/or optional recognition of a dynamic object depending on the ascertained plausibilized or filtered object positions and/or ascertainment of a movement of the dynamic object depending on the ascertained plausibilized or filtered object positions may optionally be provided. In addition, the downstream processing unit may optionally be configured to recognize a type of object depending on the ascertained plausibilized or filtered object positions by means of a trained machine recognition method. Furthermore, the downstream processing unit may optionally be configured such that it determines a warning depending on ascertained plausibilized or filtered object positions. The downstream processing unit is configured to generate an ECU output signal depending on the preprocessed sensor data, wherein the ECU output signal of the downstream processing unit is provided, as an output signal of the adapter device for the vehicle bus, at the adapter signal output. This advantageous optional embodiment eliminates the preprocessing steps of the sensor data on the central or zonal processing unit, as a result of which only higher-level processes are necessary on this unit and it can be designed to be smaller and generates less waste heat.

According to an example embodiment of the present invention, it may preferably be provided that the downstream processing unit is configured such that the software or operating parameters of the downstream processing unit can be updated through the electrical communication connection of the vehicle bus between the adapter device and the central or zonal processing unit of the vehicle, wherein the communication connection is in particular bi-directional or makes bi-directional communication possible. In particular, a software version on the downstream processing unit of the adapter device can be updated via the adapter signal output as a standardized communication interface of the communication connection of the vehicle bus, for example an Ethernet bus. As a result, improved preprocessing methods for the sensor data can be loaded onto the downstream processing unit, preferably by means of a wireless connection of a central or zonal processing unit to a server apparatus.

In a particularly preferred example embodiment of the present invention, the adapter signal input is configured to be plugged directly onto the sensor signal output and, in particular, to be connected thereto in a firmly bonded or form-fitting manner. For example, the adapter signal input can be plugged directly onto the sensor signal output and connected thereto in a firmly bonded manner, preferably glued and/or welded, or in a form-fitting manner. This results in the advantage that cabling costs can be saved and loosening of the electrical contacts due to vibrations can be avoided over the service life of the adapter device. The direct connection of the adapter device to the ultrasonic sensor also creates a very good sealing of the electrical contact between the adapter device and the ultrasonic sensor, so that the sealing technology at the interfaces can be designed to be more cost-effective. As a result, the ultrasonic sensors can be manufactured in a standardized manner in the typical way, wherein one of the ultrasonic sensors can subsequently, for example, be connected to the adapter device and take over the control of the other ultrasonic sensors.

In an advantageous example embodiment of the present invention, the control ASIC and/or the downstream processing unit of the adapter device is configured to generate the output signal for the vehicle bus, for example a CAN bus or Ethernet bus.

In an alternative example embodiment of the present invention, the adapter signal output is configured to be electrically connected to a signal input of the central or zonal processing unit by means of a cable or wirelessly via a radio connection or to be plugged directly onto the signal input of the central processing unit. This results in the advantage that costs can be saved and/or the adapter device can be positioned more flexibly and/or ultrasonic sensors of the front and rear bumper can be captured by an adapter device and/or the installation space can be used more flexibly. The adapter device being plugged directly onto the signal input of the central processing unit results in the advantage that one cable of the vehicle bus is saved.

In an optional example embodiment of the present invention, the adapter device comprises a cooling apparatus on an outer side of the adapter device housing. As a result, the waste heat can be dissipated efficiently, in particular the waste heat from the downstream processing unit of the adapter device.

In a development of the present invention, the adapter device comprises a status analysis apparatus, which is configured to ascertain information about the state of the ultrasonic sensors depending on the captured sensor signal and to generate an analysis signal depending on the ascertained state, which analysis signal is provided to the control ASIC and/or the downstream processing unit or is provided at the adapter signal output. The state of the ultrasonic sensors is, for example, operational, a defect, contamination, freezing, or a recognized inaccuracy in the distance data ascertained by the sensor ASIC. Alternatively or additionally, depending on the ascertained state and/or depending on the elapse of a specified time period, the status analysis apparatus is configured to transmit a calibration signal to at least one ultrasonic sensor. This development results in the advantage that the quality of the sensor data is retained and/or information about a decreasing quality of the sensor data is sent to the control device or the central vehicle processing unit so that the user is informed and/or the control processes can be adapted accordingly depending on a decreasing quality.

In another development of the present invention, the adapter device comprises a display apparatus, which is configured to display information about the captured sensor data or sensor signals and/or about the control of the ultrasonic sensors and/or about the ascertained state.

According to an example embodiment of the present invention, it may furthermore be provided that the control ASIC of the adapter device is configured to adapt the transmission pattern depending on the captured sensor signal and/or depending on the ascertained state of the ultrasonic sensors and/or depending on weather information received via the vehicle bus. This ensures the quality or reliability of the captured sensor signals, in particular the accuracy of the captured sensor signals or the captured distance data, since, for example, a defective or frozen ultrasonic sensor is no longer taken into account in the transmission pattern.

The present invention also relates to a driving assistance system, advantageously a parking pilot system, comprising at least three ultrasonic sensors, each having a sensor ASIC, wherein the three ultrasonic sensors are configured to be connected to one another by means of an ultrasonic bus. The driving assistance system furthermore comprises an optional central or zonal processing unit of the vehicle. The driving assistance system also comprises the adapter device according to the present invention.

The present invention furthermore relates to a vehicle comprising the driving assistance system according to the present invention.

Further advantages of the present invention arise from the following description of exemplary embodiments with respect to the figures.

### BRIEF DESCRIPTION OF THE DRAWINGS

FIG. 1 shows a driving assistance system, adapter device on the central vehicle processing unit, according to an example embodiment of the present invention.

FIG. 2 shows structure of the adapter device on the central vehicle processing unit, according to an example embodiment of the present invention.

FIG. 3 shows a driving assistance system, variant of the adapter device on the ultrasonic sensor, according to an example embodiment of the present invention.

FIG. 4 shows a structure of the adapter device on the ultrasonic sensor with the vehicle bus, according to an example embodiment of the present invention.

### DETAILED DESCRIPTION OF EXAMPLE EMBODIMENTS

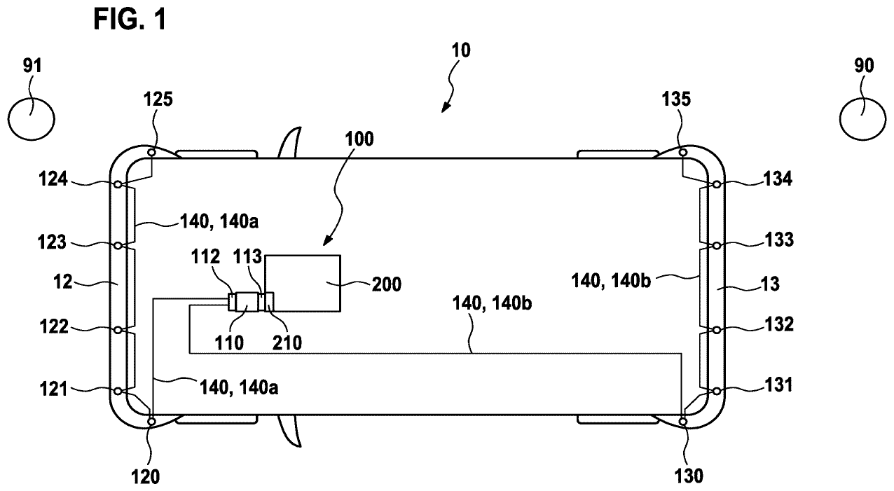

FIG. 1 schematically shows a driving assistance system 100 on a vehicle 10 shown schematically in plan view. The driving assistance system 110 of FIG. 1 is configured to assist the driver or user of the vehicle 10 when parking partially autonomously or fully automatically, by displaying, to the user, information about objects 90, 91 in the environment of the vehicle 10, for example by means of a display in the vehicle interior, and/or by controlling the drive, brakes and/or steering of the vehicle 10, for example by means of a drive motor, a brake actuator or a steering system of the vehicle 10, wherein distance information or distance data to the objects 90, 91 are captured or ascertained by ultrasonic sensors 120 to 125 and 130 to 135 and are taken into account in particular in the trajectory planning. The driving assistance system 100 comprises an adapter device 110 and front ultrasonic sensors 120 to 125, which are arranged on the front bumper 12 of the vehicle 10, as well as rear ultrasonic sensors 130 to 135, which are arranged on the rear bumper 13 of the vehicle 10. The front ultrasonic sensors 120 to 125 are electrically connected to one another and to an adapter signal input 112 of the adapter device 110 by means of an ultrasonic bus 140 or front ultrasonic bus 140a, wherein the adapter signal input 112 preferably has a socket for each of the front ultrasonic sensors 120 to 125 and for each of the rear ultrasonic sensors 130 to 135. The ultrasonic sensors 130 to 135 are likewise electrically connected to one another and to the adapter signal input 112 of the adapter device 110 by means of an ultrasonic bus 140 or a rear ultrasonic bus 140b. Preferably, the ultrasonic bus 140 is a daisy chain bus in each case. The front ultrasonic bus 140a connects the front ultrasonic sensors 120 to 125 to one another and to the adapter device 110 and comprises at least one cable for this purpose. The rear ultrasonic bus 140b connects the rear ultrasonic sensors 130 to 135 to one another and to the adapter device 110 and comprises at least one cable for this purpose. In this example, the adapter signal output 113 of the adapter device 110 is directly electrically connected to the signal input 210 of a central vehicle processing unit 200; for example, the adapter signal output 113 is plugged to or onto a signal input 210 of the central vehicle processing unit 200. The adapter signal output of the adapter device 110 and the signal input 210 of the central vehicle processing unit 200 are preferably designed as a plug or socket of a standardized communication interface of a vehicle bus, for example as a plug or socket of a CAN or Ethernet vehicle bus.

The corresponding vehicle bus cable can comprise at least one wire for the energy or current/voltage supply of the adapter device 110 and/or of the ultrasonic sensors 120 to 125 and 130 to 135; for example, the vehicle bus comprises two wires for data communication as well as a ground wire and a supply wire, wherein the supply wire has a 5V potential difference from the ground wire. In other words, the adapter signal output 113 is configured to provide or generate an output signal of the adapter device 110 for the vehicle bus, wherein the generated output signal in particular fulfills the requirements of a standard of a vehicle bus.

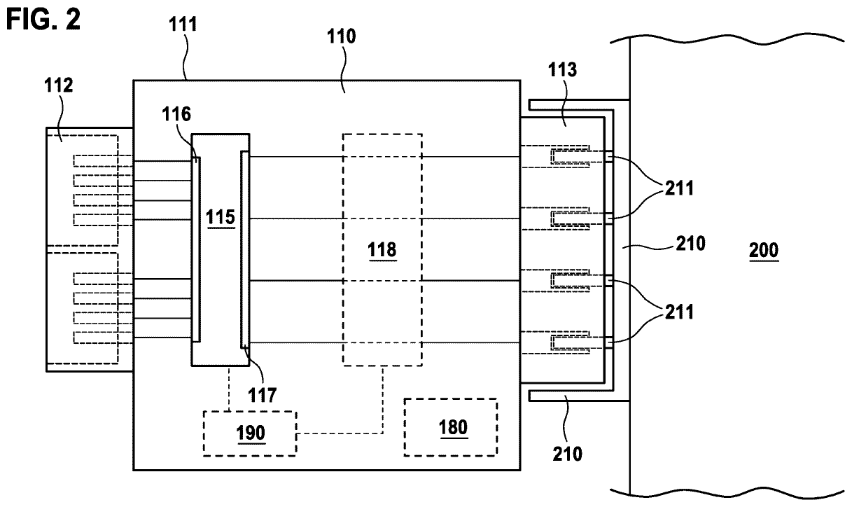

FIG. 2 shows a schematic structure of the adapter device 110, which is arranged according to FIG. 1 with an adapter signal output 113 at the signal input 210 of the central vehicle processing unit 200. The central vehicle processing unit 200 has a socket with electrical contacts 211 as a signal input 210. The adapter device 110 comprises a plug or a plug unit as an adapter signal output 113 on the adapter device housing 111, wherein the adapter signal output is configured to generate an output signal of the adapter device for the vehicle bus. The adapter signal output 113 is configured to be plugged into the socket 210 and to electrically contact the electrical contacts 211 of the signal input 210 of the central vehicle processing unit 200. The adapter device 110 furthermore comprises an adapter signal input 112. The adapter device 110 furthermore comprises the control ASIC 115. The control ASIC 115 is arranged in the adapter device housing 111 and electrically connected to the adapter signal input 112. The control ASIC 115 is configured to capture the sensor signal(s), provided at the adapter signal input 112 by means of the ultrasonic bus 140, from the ultrasonic sensors 120 to 125 and 130 to 135 at an ASIC signal input 116. The control ASIC 115 is furthermore configured to generate an ASIC output signal at an ASIC signal output 117 on the basis of the at least one captured sensor signal, which ASIC output signal is advantageously provided, as an output signal of the adapter device 110, at the adapter device output. The ASIC output signal may conform to a standard for a vehicle bus and be provided at the adapter signal output or alternatively may be captured by an optional downstream processing unit 118 of the adapter device. In a particularly preferred embodiment, the optional downstream processing unit 118 is omitted, resulting in a compact, cost-effective and energy-efficient adapter control device.

The control ASIC 115 therefore preferably prepares or adapts the sensor signal(s) of the ultrasonic bus according to a standard for the vehicle bus. The control ASIC 115 is furthermore configured to control the ultrasonic sensors 120 to 125 and 130 to 135, in particular according to a specified transmission pattern. The control comprises an activation of at least one and preferably a plurality of ultrasonic sensors 120 to 125 and 130 to 135 per cycle for transmitting an ultrasonic signal and a synchronization with the other or non-transmitting ultrasonic sensors 120 to 125 and 130 to 135 of the same cycle, in particular for receiving the reflected ultrasonic signal or the echo signals. In the particularly preferred embodiment, the control ASIC 115 is thus configured such that it converts or adapts the sensor signals, provided at the adapter signal input, at the adapter signal output according to a communication protocol or communication standard or standard for the vehicle bus and also controls or synchronizes the ultrasonic sensors 120 to 125 and 130 to 135 according to a specified transmission pattern. The ultrasonic sensors 120 to 125 and 130 to 135 are preferably controlled by means of a control data signal, which is transmitted by means of the ultrasonic bus. The tasks of the control ASIC 115 of the adapter device 110 in a central or zonal processing unit of the vehicle would unnecessarily limit the electrical and mechanical design of the central processing unit and make it more expensive. The adapter device 110 comprising a control ASIC 115 can be manufactured particularly advantageously and adapted flexibly, in particular if it is connected directly to a central or zonal vehicle processing unit 200 by means of the vehicle bus without a downstream processing unit 118, wherein the vehicle processing unit preferably carries out the preparation or preprocessing and the interpretation as well as the further processing of the sensor data.

In an alternative embodiment, which is shown in dashed lines in FIG. 2, the optional downstream processing unit 118 of the adapter device 110 is configured to preprocess or prepare the sensor data of the sensor signal. The preprocessing comprises at least one ascertainment of object positions between the vehicle and an object in the environment of the vehicle on the basis of the distance data of the sensor data or of the sensor signal. The optional downstream processing unit 118 also generates an ECU output signal depending on the preprocessed sensor data according to a standard of the vehicle bus. The ECU output signal is transmitted to or provided at the adapter signal output 113 and captured by the signal input 210 of the vehicle processing unit 200. The vehicle processing unit 200 advantageously ascertains further variables, for example driving trajectories for the vehicle, on the basis of the sensor data and/or the preprocessed sensor data and controls the vehicle and/or displays information about the environment of the vehicle to the driver or user. Optionally, the adapter device 110 comprises a status analysis apparatus 190, which is configured to ascertain information about the state of the ultrasonic sensors 120 to 125 and 130 to 135 depending on the sensor signal and to provide it to the control ASIC or the adapter signal output 113 and/or to transmit a calibration signal to the ultrasonic transmitter. The state of the ultrasonic sensors 120 to 125 and 130 to 135 may, for example, be a defect, contamination, freezing, or recognized qualitatively decreasing or inadequate distance data. Optionally, the adapter device 110 comprises a display apparatus 180, in particular a display, which is configured to display information about the captured sensor data or sensor signals and/or about the control of the ultrasonic sensors 120 to 125 and 130 to 135 and/or the ascertained state of the ultrasonic sensors 120 to 125 and 130 to 135.

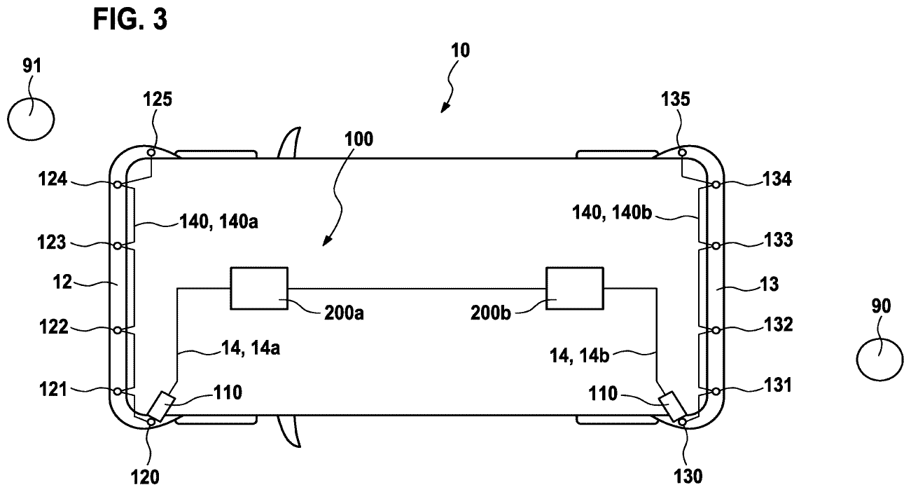

Similarly to FIG. 1, FIG. 3 schematically shows a driving assistance system 100 on a vehicle 10 shown schematically in plan view. The driving assistance system 110 of FIG. 3 is likewise configured to assist the driver or user of the vehicle 10 when parking partially autonomously or fully automatically, by displaying, to the user, information about objects 90, 91 in the environment of the vehicle 10, for example by means of a display in the vehicle interior, and/or by controlling the drive, brakes and/or steering of the vehicle 10, for example by means of a drive motor, a brake actuator or a steering system of the vehicle 10, wherein distance information or distance data to the objects 90, 91 are captured or ascertained by ultrasonic sensors 120 to 125 and 130 to 135 and are taken into account in particular in the trajectory planning. The driving assistance system 100 comprises a front adapter device 110, 110a, which is arranged directly on the front ultrasonic sensor 120. The front ultrasonic sensor 120 is connected to the other front ultrasonic sensors 121 to 125 by means of the ultrasonic bus 140, 140a. The front ultrasonic sensors 120 to 125 are arranged or mounted on the front bumper 12 of the vehicle 10. The driving assistance system 100 also comprises a rear adapter device 110, 110b, which is arranged directly on the rear ultrasonic sensor 130. The rear ultrasonic sensor 130 is connected to the other rear ultrasonic sensors 131 to 135 by means of a further ultrasonic bus 140, 140b. The rear ultrasonic sensors 130 to 135 are arranged or mounted on the rear bumper 13 of the vehicle 10. Preferably, the ultrasonic buses 140, 140a and 140b are each a daisy chain bus. The front adapter device 110, 110a is connected to the central front processing unit 200 or the front zonal processing unit 200a of the vehicle 10 by means of the front vehicle bus 14, 14a, and the rear adapter device 110, 110b is connected to the central rear processing unit 200 or the rear zonal processing unit 200b of the vehicle 10 by means of the rear vehicle bus 14, 14b. In this example, the central processing unit 200 comprises a central front or front zonal processing unit 200a and a central rear or rear zonal processing unit 200b. Alternatively, the front vehicle bus 14, 14a and the rear vehicle bus 14, 14b could be connected to a single-part central processing unit 200 (not shown here).

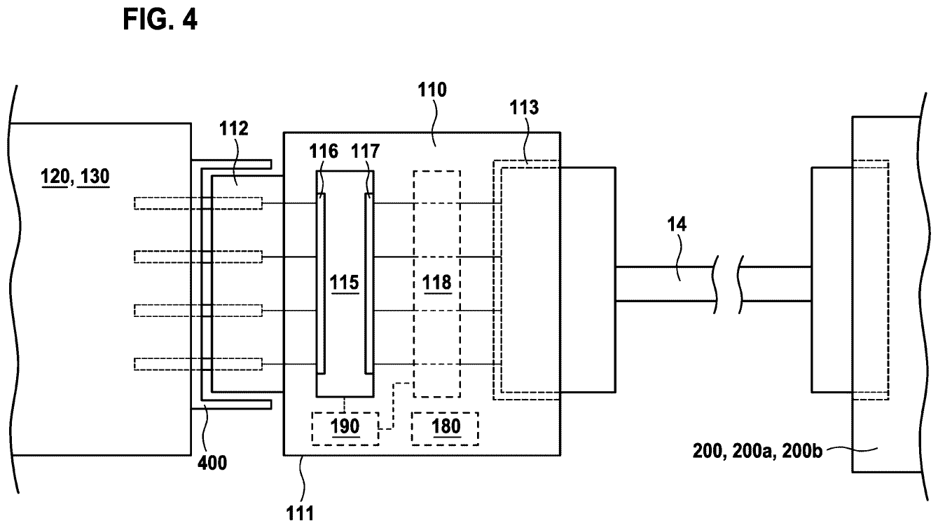

Similarly to FIG. 2, FIG. 4 shows a schematic structure of the adapter device 110. In FIG. 4, according to FIG. 3, the adapter device 110 comprising an adapter signal input 112 is directly connected to, for example plugged into, a sensor signal output 400 of an ultrasonic sensor 120, 130. For this purpose, the ultrasonic sensor 120, 130 has a sensor signal output 400, which comprises a socket or a plug with electrical contacts 410. For this purpose, the adapter device 110 comprises a corresponding plug or a socket or a plug unit as an adapter signal input 112 on the adapter device housing 111. The adapter device 110 is furthermore connected with an adapter signal output 113 to the central processing unit 200 or the zonal processing units 200a or 200b of the vehicle 10 by means of the vehicle bus 14. The remaining functions and advantages of the adapter device 110 correspond to those of FIG. 2 and FIG. 3, according to the structural change. The adapter device 110 in particular comprises the control ASIC 115. The control ASIC 115 is arranged in the adapter device housing 111 and electrically connected to the adapter signal input 112. The control ASIC 115 is configured to capture the sensor signal, provided at the adapter signal input 112 by means of the sensor signal output 400, at an ASIC signal input 116. The control ASIC 115 is configured to generate an ASIC output signal at an ASIC signal output 117 on the basis of the at least one captured sensor signal. In the particularly preferred embodiment, the control ASIC 115 is configured such that it converts the sensor signals, provided at the adapter signal input, at the adapter signal output 113 according to a standard for the vehicle bus 14. The control ASIC 115 is furthermore configured to control the ultrasonic sensors 120 to 125 and 130 to 135, wherein the control is carried out via the ultrasonic sensor 120, 130 by means of the ultrasonic bus according to a specified transmission pattern. The ultrasonic sensors 120 to 125 and 130 to 135 are preferably controlled by means of a control data signal, which is transmitted by means of the ultrasonic bus 140, 140a, 140b. An optional downstream processing unit 118 of the adapter device 110 is configured to preprocess or prepare the sensor data of the sensor signal. The preprocessing comprises at least one ascertainment of object positions between the vehicle and an object in the environment of the vehicle on the basis of the distance data of the sensor data or of the sensor signal. The optional downstream processing unit 118 also generates an ECU output signal depending on the preprocessed sensor data according to a standard of the vehicle bus. Optionally, the adapter device 110 comprises the status analysis apparatus 190 and/or the display apparatus 180, see the description of FIG. 2 in each case.

1-10. (canceled)

11. An adapter device configured for arrangement within an electrical communication connection between at least one ultrasonic sensor and a central or zonal processing unit of a vehicle, the adapter device comprising:
an adapter device housing;
an adapter signal input configured to be electrically connected to at least one sensor signal output of an ultrasonic sensor and to provide a sensor signal of the ultrasonic sensor;
an adapter signal output configured to generate an output signal of the adapter device for a vehicle bus connection to the central or zonal processing unit; and
at least one control ASIC arranged in the adapter device housing and configured to:
i. capture the provided sensor signal,
ii. generate an ASIC output signal of the control ASIC depending on the captured sensor signal, and
iii. control the at least one ultrasonic sensor based on a specified transmission pattern.

12. The adapter device according to claim 11, wherein the adapter device further comprises:
a downstream processing unit electrically connected to an ASIC signal output of the control ASIC and to the adapter signal output and configured to:
i. preprocess sensor data of the sensor signal based on the ASIC output signal, wherein the preprocessing includes at least one ascertainment of object positions between the vehicle and an object in an environment of the vehicle based on the sensor data, and
ii. generate an ECU output signal at the adapter signal output depending on the preprocessed sensor data.

13. The adapter device according to claim 12, wherein the downstream processing unit is configured such that software or operating parameters of the downstream processing unit are updated through the electrical communication connection between the adapter device and the central or zonal processing unit of the vehicle.

14. The adapter device according to claim 11, wherein the adapter signal input is configured to be plugged directly onto the sensor signal output and to be firmly bonded or form-fitted to the sensor signal output.

15. The adapter device according to claim 12, wherein the control ASIC and/or the downstream processing unit of the adapter device is configured to generate the output signal of the adapter device at the adapter signal output according to a standard of a vehicle bus.

16. The adapter device according to claim 11, wherein the adapter signal output is: (i) configured to be electrically connected to a signal input of the central or zonal processing unit via a radio connection, or (ii) configured to be plugged directly onto the signal input of the central processing unit.

17. The adapter device according to claim 11, wherein the adapter device includes a status analysis apparatus configured to ascertain information about a state of the ultrasonic sensors depending on the captured sensor signal and to: (i) provide the information to the control ASIC or the adapter signal output, or (ii) to transmit a calibration signal to the ultrasonic sensor.

18. The adapter device according to claim 11, wherein the control ASIC is configured to adapt the transmission pattern depending on: (i) the captured sensor signal and/or (ii) an ascertained state of the ultrasonic sensors and/or (iii) weather information received via the vehicle bus.

19. A driving assistance system, comprising:
at least one ultrasonic sensor including a sensor ASIC;
a central or zonal processing unit of a vehicle; and
an adapter device configured for arrangement within an electrical communication connection between the at least one ultrasonic sensor and the central or zonal processing unit of the vehicle, the adapter device including:
an adapter device housing,
an adapter signal input configured to be electrically connected to at least one sensor signal output of an ultrasonic sensor and to provide a sensor signal of the ultrasonic sensor,
an adapter signal output configured to generate an output signal of the adapter device for a vehicle bus connection to the central or zonal processing unit, and
at least one control ASIC arranged in the adapter device housing and configured to:
i. capture the provided sensor signal,
ii. generate an ASIC output signal of the control ASIC depending on the captured sensor signal, and
iii. control the at least one ultrasonic sensor based on a specified transmission pattern.

20. A vehicle, comprising
a driving assistance system including:
at least one ultrasonic sensor including a sensor ASIC;
a central or zonal processing unit of the vehicle; and
an adapter device configured for arrangement within an electrical communication connection between the at least one ultrasonic sensor and the central or zonal processing unit of the vehicle, the adapter device including:
an adapter device housing,
an adapter signal input configured to be electrically connected to at least one sensor signal output of an ultrasonic sensor and to provide a sensor signal of the ultrasonic sensor,
an adapter signal output configured to generate an output signal of the adapter device for a vehicle bus connection to the central or zonal processing unit, and
at least one control ASIC arranged in the adapter device housing and configured to:
i. capture the provided sensor signal,
ii. generate an ASIC output signal of the control ASIC depending on the captured sensor signal, and
iii. control the at least one ultrasonic sensor based on a specified transmission pattern.
